(19) United States
(12) Patent Application Publication
(10) Pub. No.: US 2026/0244038 A1
(43) Pub. Date: Aug. 20, 2026

(54) Optical Modulator

(71) Applicant: NTT, Inc., Tokyo (JP)

(72) Inventors: Ken Tsuzuki, Musashino-shi, Tokyo (JP); Makoto Jizodo, Musashino-shi, Tokyo (JP)

(21) Appl. No.: 18/872,120

(22) PCT Filed: Jun. 10, 2022
(86) PCT No.: PCT/JP2022/023512

§ 371 Date: Dec. 5, 2024

(51) Int. Cl. G02F 1/025; G02F 1/01; G02F 1/21; G02F 1/225

(52) U.S. Cl. CPC G02F 1/025; G02F 1/0123; G02F 1/212; G02F 1/2255

(57) ABSTRACT

Provided is an optical modulator that can be adjusted to an optimum bias condition even in a dual-electrode type structure. An optical modulator including a semiconductor layer with a pn junction in an optical waveguide core, and an RF electrode and a ground electrode for applying a radio frequency (RF) signal to the semiconductor layer, the optical modulator modulating an optical signal by applying a bias voltage to the semiconductor layer together with the RF signal, the optical modulator including: a bias electrode disposed to face the ground electrode inside a substrate, in which the RF electrode and the bias electrode are connected to the semiconductor layer.

### TECHNICAL FIELD

The present invention relates to an optical modulator, and more particularly to an optical modulator that is used in an optical communication system, an optical information processing system, and the like, performs an optical modulation operation at a high speed, has excellent frequency characteristics and waveform quality, and can perform optical communication over a long distance.

### BACKGROUND ART

Due to the spread of high-definition video distribution services and mobile communication, the amount of traffic flowing through a network has become enormous and has been increasing year by year. In order to construct a high-speed and large-capacity optical network capable of meeting such traffic demands, development of a basic device capable of high-speed operation used in each node has been energetically performed. An optical modulator that directly modulates an optical signal with a broadband baseband signal is one of important devices.

A Mach-Zehnder (MZ) type optical modulator has a structure in which light incident on an optical waveguide is split into two waveguides at an intensity of 1:1, and the pieces of split light are caused to propagate for a certain length and then are multiplexed again. In the MZ type optical modulator, phases of the two pieces of split light are changed by phase modulation portions provided in the two split optical waveguides. The intensity and the phase of the light can be modulated by changing the interference condition of the light when the two pieces of light subjected to the phase change are multiplexed.

As a material constituting the optical waveguides of the MZ type optical modulator, a dielectric such as LiNbO₃, or a semiconductor such as InP, GaAs, or Si is used. By inputting a modulation electrical signal to an electrode disposed in the vicinity of the optical waveguide made of the material described above and applying a modulation voltage to the optical waveguide, the phase of light propagating through the optical waveguide is changed.

As a mechanism for changing the phase of light in the MZ type optical modulator, the Pockels effect is used when the material is LiNbO₃. When the material is InP or GaAs, the Pockels effect and the quantum-confined Stark effect (QCSE) are used, and when the material is Si, the carrier plasma effect is mainly used.

In order to perform high-speed and low-power-consumption optical communication, an optical modulator with a high modulation speed and a low drive voltage is required. Specifically, it is required to perform optical modulation at a high speed of 10 Gbps or more and with an amplitude voltage of several volts. In order to achieve this, a traveling-wave electrode is required that matches the speed of a high-speed electrical signal and the speed of light propagating through a phase modulator, and allows the light and electrical signal to interact as they propagate. As an optical modulator using a traveling-wave electrode, for example, as disclosed in Non Patent Literature 1, an optical modulator with an electrode length of several mm to several tens of mm has been put into practical use.

In an optical modulator using a traveling-wave electrode, an electrode structure and an optical waveguide structure with low loss and less reflection are required so that the propagation can be performed without decreasing the amplitude of the electrical signal and the intensity of light propagating through the waveguide. That is, an electrode structure with less reflection loss and propagation loss over a wide frequency band is required for the electrical signal, and a waveguide structure capable of efficiently confining light with less reflection and propagating the light without loss is required for the light.

As a promising MZ type optical modulator from the viewpoint of a substrate material and a manufacturing process, there is a Si optical modulator in which an optical waveguide is made of Si. The Si optical modulator is manufactured from a silicon on insulator (SOI) substrate in which a thin film of Si is attached onto a buried oxide (BOX) layer obtained by thermally oxidizing the surface of the Si substrate. In the optical waveguide, a Si thin film is processed into a thin line so that light can be guided through the SOI layer, and then impurities are injected so that a p-type semiconductor and an n-type semiconductor can be formed. Finally, SiO₂ to be a cladding layer of light is deposited, formation of an electrode, and the like are formed to manufacture the electrode.

At this time, the waveguide of light needs to be designed and processed so as to reduce the light loss. Specifically, p-type and n-type impurity doping and manufacture of the electrode need to be designed and processed so as to suppress light loss and to suppress reflection loss and propagation loss of a high-speed electrical signal.

FIG. 1 illustrates a cross-sectional structure of an optical waveguide as the basis of a Si optical modulator of a conventional technique. FIG. 1 illustrates a cross-section (x-z plane) of an optical waveguide 200 formed on an SOI substrate, cut perpendicularly to a light traveling direction (y-axis). The light propagates in a direction perpendicular to the paper surface (y-axis direction). The optical waveguide 200 of the Si optical modulator includes a Si layer 2 sandwiched between upper and lower SiO₂ cladding layers 1 and 3. The Si thin line formed at the center of FIG. 1 for confining light has a structure called a rib waveguide with a difference in thickness. That is, as illustrated in FIG. 1, the rib waveguide includes a Si layer 201 that is thick at the central portion and slab regions 202a and 202b that are thin on both sides thereof. The Si layer 201 that is thick at the center of the Si layer 2 is used as a core, and a refractive index difference with respect to the surrounding SiO₂ cladding layers 1 and 3 is used to constitute the optical waveguide 200 that confines light propagating in the direction perpendicular to the paper surface.

In the slab regions 202a and 202b that are thin on both sides of the optical waveguide core of the thick Si layer 201, a high-concentration p-type semiconductor layer 211 and a high-concentration n-type semiconductor layer 214 are provided, respectively. Further, a pn junction structure including a medium-concentration p-type semiconductor layer 212 and a medium-concentration n-type semiconductor layer 213 is formed in the optical waveguide core of the Si layer 201 and the vicinity thereof. As described below, a modulation electrical signal and a bias voltage are applied from both left and right ends of the Si layer 2 in FIG. 1 via electrodes, which are not illustrated. Instead of the pn junction at the central portion of the core, a pin structure may be adopted in which an undoped i-type (intrinsic) semiconductor is sandwiched in the pn junction structure of the medium-concentration p-type semiconductor layer 212 and the medium-concentration n-type semiconductor layer 213.

The phase modulation operation in the optical waveguide 200 of the Si optical modulator can be described as the following. Although not illustrated in FIG. 1, two metal electrodes in contact with the high-concentration p-type semiconductor layer 211 and the high-concentration n-type semiconductor layer 214 at both ends of the Si layer 2 are provided. A reverse bias voltage is applied to the pn junction portion at the center of the core via the two metal electrodes together with a radio frequency (RF) modulation electrical signal. That is, a voltage with a positive potential on the high-concentration n-type semiconductor layer 214 side and a negative potential on the high-concentration p-type semiconductor layer 211 side is applied from the right end to the left end of the optical waveguide 200 (in the x-axis direction). The reverse bias voltage and the modulation electrical signal change the carrier density inside the core of the thick Si layer 201. With changing the carrier density to cause a change in the refractive index of the core 201 of the optical waveguide due to the carrier plasma effect, the phase of light propagating through the core of the optical waveguide can be modulated.

The dimensions of the optical waveguide in the Si optical modulator depend on the refractive index of each material serving as the core/cladding. An example in the case of a rib type silicon waveguide structure with the core part of the thick Si layer 201 and the slab regions 202a and 202b on both sides thereof as illustrated in FIG. 1 will be listed. The width (x-axis direction) of the optical waveguide core 201 is 400 to 600 (nm), the height (z-axis direction) of the core portion is 150 to 300 (nm), the thickness of the slab region is 50 to 200 (nm), and the length (y-axis direction) of the optical waveguide is about several (mm).

One of the excellent features of the Si optical modulator is that a refractive index difference between Si as the core through which light propagates and SiO₂ of the cladding layer is large, so that a compact optical modulator can be configured. Since the refractive index difference is large, light can be confined small, and the bending radius of the optical waveguide can be made as very small as about 10 μm. Therefore, a light multiplexer/demultiplexer circuit portion in the Si optical modulator to be described next can be configured small.

### (Conventional Single-Electrode Type Mach-Zehnder Type Optical Modulator)

FIGS. 2 and 3 illustrate a Si optical modulator constituting a conventional single-electrode type Mach-Zehnder type optical modulator (see, for example, Non Patent Literature 2). FIG. 2 illustrates a planar structure of a Si (SOI) substrate surface (x-y plane) seen through from above, and FIG. 3 illustrates a cross-sectional structure of III-III′ in FIG. 2. In the plan diagram of FIG. 2, a light input from a left optical modulator end is split into two optical waveguides 7a and 7b, and phase-modulated by a modulation electrical signal (RF signal) applied between upper and lower RF electrodes 5a and 5b and a central DC electrode 6. After being modulated, they are coupled again and optically output as modulated light from a right optical modulator end.

In the cross-sectional diagram of FIG. 3, the Si optical modulator has a basic structure in which two optical waveguides with a cross-sectional structure similar to that of the optical waveguide 200 illustrated in FIG. 1 are arranged symmetrically. Two radio frequency lines (RF electrodes 5a and 5b) for inputting a pair of differential modulation electrical signals (RF signals) are provided on both sides, and a DC electrode 6 for applying a common bias voltage is provided therebetween. Two optical waveguides 7a and 7b are provided between the two RF electrodes 5a and 5b across the DC electrode 6, and pn junction structures are formed symmetrically in the optical waveguides 7a and 7b. The RF electrodes 5a and 5b are in contact with high-concentration p-type semiconductor layers 211a and 211b, respectively.

The DC electrode 6 is in contact with the high-concentration n-type semiconductor layer 214 at the center, and by applying a positive voltage with respect to the RF electrodes 5a and 5b to the DC electrode 6, a reverse bias can be applied to the left and right two pn junction portions. Note that although the same applies hereinafter, these electrodes and the semiconductor layers are electrically connected by one or a plurality of vias 4 (through-electrodes).

In such a single-electrode Si optical modulator, the RF electrode and the DC electrode are electrically independent, and it is not necessary to actively apply a bias voltage to the RF electrode in order to apply a reverse bias to the pn junction. Here, the example in which the RF electrode is in contact with the p-type semiconductor layer and the DC electrode is in contact with the n-type semiconductor layer has been described, but the RF electrode may be in contact with the n-type semiconductor layer and the DC electrode may be in contact with the p-type semiconductor layer. As the bias voltage applied to the DC electrode at this time, a reverse bias can be applied to the pn junction portion by applying a negative voltage with respect to the RF electrode.

### (Conventional Dual-Electrode Type Mach-Zehnder Type Optical Modulator)

FIG. 4 illustrates a Si optical modulator constituting a conventional dual-electrode type Mach-Zehnder type optical modulator. It is a planar structure in which a Si (SOI) substrate surface (x-y plane) seen through from above. The light input from the left optical modulator end is split into two optical waveguides 7a and 7b, modulated, and then coupled again, and to be optically output as modulated light from the right optical modulator end. The input light is phase-modulated by the modulation electrical signal (RF signal) applied to each of RF electrodes 15a and 15b while propagating through the two split optical waveguides 7a and 7b in the y-axis direction. The optical modulator has a coplanar waveguide (CPW) including two ground electrodes 16a and 17 sandwiching the RF electrode 15a for the optical waveguide 7a. Similarly, it has a CPW including two ground electrodes 16b and 17 sandwiching the RF electrode 15b for the optical waveguide 7b.

Since a configuration with two RF signal input portions in a single Mach-Zehnder (MZ) type optical modulator, it is called a dual-electrode structure. The MZ type optical modulator illustrated in FIG. 4 has a symmetrical structure with respect to a center line parallel to the y axis passing through the center of the ground electrode 17.

FIG. 5 illustrates a cross-sectional structure of V-V′ in FIG. 4, and illustrates only the phase modulation portion including the CPW corresponding to one optical waveguide 7a that is subjected to a modulation. One phase modulation portion is an optical waveguide with a cross-sectional structure similar to that of the optical waveguide 200 illustrated in FIG. 1. The RF electrode 15a that is a radio frequency line to which one of the pair of differential modulation electrical signals (RF signals) is input, and the two ground electrodes 16a and 17 provided so as to sandwich the RF electrode 15a are included. One optical waveguide core 7a is provided between the RF electrode 15a and the ground electrode 16a, and a pn junction structure including the medium-concentration p-type semiconductor layer 212 and the medium-concentration n-type semiconductor layer 213 is formed in the optical waveguide 7a. The RF electrode 15a is in contact with the high-concentration n-type semiconductor layer 214 through a via 19b. In addition, the ground electrode 16a is in contact with the high-concentration p-type semiconductor layer 211 through a via 19a.

The ground electrode 17 is not in contact with any semiconductor layer, but forms a radio frequency transmission line (CPW) with a ground-signal-ground (GSG) structure for the RF electrode 15a together with the ground electrode 16a. With this transmission line structure, the characteristic impedance as the transmission line of the RF electrode can be adjusted to improve the transmission characteristics. In addition, since the signal line by the RF electrode 15a is surrounded by the two ground electrodes 16a and 17, it is possible to form an optical modulator with less signal leakage, and less crosstalk or propagation loss.

Note that FIG. 5 illustrates the phase modulation portion including the RF electrode 15a, which is a radio frequency line to which one of the modulation electrical signals (RF signals) with a differential configuration is input, but the phase modulation portion including the other RF electrode 15b also has a similar configuration to that of FIG. 5 except that the disposition order of the plurality of semiconductor regions in the x-axis direction is reversed with respect to the z axis as the symmetry axis.

The characteristic impedance as a radio frequency transmission line in the RF electrodes 15a and 15b of the Si optical modulator is significantly affected by the electrostatic capacitance of the pn junction portion of the optical waveguide cores 7a and 7b of the Si layer. However, since the electrostatic capacitance between the RF electrode and the ground electrode also affects, in the Si modulator with a dual-electrode structure, it is relatively easy to adjust the characteristic impedance by adjusting the electrostatic capacitance between the RF electrode 15a and the ground electrode 17. The characteristic impedance can be set to about 50Ω in the single-end drive configuration and about 100Ω in the differential drive configuration.

Here, the configuration example in which the RF electrode 15a is in contact with the high-concentration n-type semiconductor layer 214 and the ground electrode 16a is in contact with the high-concentration p-type semiconductor layer 211 has been described. On the other hand, the direction of the pn junction may be reversed, and the RF electrode 15a may be in contact with the high-concentration p-type semiconductor layer, and the ground electrode 16a may be in contact with the high-concentration n-type semiconductor layer. In this case, the pn junction portion can be reversely biased by applying a negative voltage to the ground electrode 16a as a bias voltage superimposed on the RF signal and given to the RF electrode 15a.

In such a dual-electrode Si optical modulator, since a DC bias voltage is applied to the RF electrode in an overlapping manner, it is necessary to devise a bias T for connection with a driver IC as compared with a single-electrode Si modulator. However, there is an advantage that adjustment of the characteristic impedance becomes relatively easy by controlling the capacitance with the ground electrode. Additionally, with being surrounded by the ground electrode, it is possible to form an optical modulator with less signal leakage, and less crosstalk or propagation loss.

### (Propagation of Radio Frequency Signal)

In order to achieve large-capacity optical communication, an optical modulator capable of light modulation at a high speed is required. In order to perform high-speed optical modulation, frequency characteristics operable over a wide frequency band of several hundred kHz to several tens of GHz are required for the optical modulator.

With reference to FIG. 6, a propagation state of an ideal modulation signal in a dual-electrode Si optical modulator with a CPW structure will be described. As described above, the RF electrode 15a is configured with the CPW which is sandwiched between the two ground electrodes 16a and 17. In the CPW, a radio frequency signal propagates on the RF electrode 15a in a state where one RF electrode 15a is sandwiched between the ground electrodes 16a and 17 on both sides. The propagation of the radio frequency signal electromagnetically can be explained as a model in which a dense portion of charges and a sparse portion of charges move like waves on a radio frequency transmission line, for example, the RF electrode 15a. As the dense portion of charges propagates, this model can be understood as an operation in which a dense portion of charges with opposite positive and negative polarities is induced by the Coulomb interaction on the ground electrode or on the paired RF electrodes of the differential lines, and moves similarly to the radio frequency signal.

The CPW is one of unbalanced lines in which the charges of the RF line are balanced with the charges with opposite polarities induced in each of the two ground electrodes. In FIG. 6, a propagation state of a modulation signal by the above-described charge movement model is schematically described by signs+/−. When an RF signal 21 is input, positive charges 22 and negative charges 23 alternately appear in the y-axis direction, which is the propagation direction of the electrical signal, on the RF electrode 15a at a certain time point. In correspondence with the dense portion of the positive charges 22 on the RF electrode 15a, dense portions 24a and 24b of negative charges with opposite polarities appear in each of the two ground electrodes 16a and 17.

In the ideal CPW, as illustrated in FIG. 6, the charges on the two ground electrodes 16a and 17 are aligned with the charges on the RF electrode 15a and propagate in the y-axis direction. For example, the distribution of charges in the x-axis direction at an output end of the optical modulator at a certain time becomes a positive maximum at the center of the RF electrode 15a, and becomes a negative distribution in each of the ground electrodes 16a and 17 on the RF electrode 15a side. At the output end, the polarity of the charge of each electrode changes with the lapse of time. The RF signal 21 propagates while applying a modulation action to the optical waveguide 7a, and is terminated at a terminating resistor connected to a right end of the RF electrode 15a, which is not illustrated. However, in the CPW in an actual Si optical modulator, there is a problem that asymmetry occurs in the movement of charges due to asymmetry of a transmission line, and a modulation signal cannot be efficiently applied to the RF electrode 15a.

FIGS. 7 and 8 illustrate a dual-electrode Si optical modulator with a conventional CPW structure (see, for example, Patent Literature 1). FIG. 7 illustrates a planar structure of a Si (SOI) substrate surface (x-y plane) seen through from above, FIG. 8(a) illustrates a cross-sectional structure of VIIIa-VIIIa′ in FIG. 7, and FIG. 8(b) illustrates a cross-sectional structure of VIIIb-VIIIb′ in FIG. 7. In order to eliminate the phase difference between the radio frequency signals of the two ground electrodes 16a and 17, a wiring electrode 41 connecting both electrodes is provided in the cladding layer 3.

FIG. 8(a) is a structure similar to the dual-electrode structure Si optical modulator of a conventional technique illustrated in FIG. 5. That is, one optical waveguide core 7a is provided between the RF electrode 15a and the ground electrode 16a, and a pn junction structure including the medium-concentration p-type semiconductor layer 212 and the medium-concentration n-type semiconductor layer 213 is formed in the optical waveguide core 7a. The RF electrode 15a is in contact with the high-concentration n-type semiconductor layer 214 through vias 42b and 44b. In addition, the ground electrode 16a is in contact with the high-concentration p-type semiconductor layer 211 through vias 42a and 44a.

FIG. 8(b) illustrates a cross-section including the wiring electrode 41. The wiring electrode 41 with a linear shape connects the two ground electrodes 16a and 17 without forming a via connected from the RF electrode 15a to the Si semiconductor layer 214. Accordingly, the wiring electrode 41 is not in contact with the RF electrode 15a and the via 42b. With the wiring electrode 41, potentials between the two ground electrodes 16a and 17 become equal. Therefore, the phase difference of return currents induced on the ground electrodes 16a and 17 and propagating through the ground electrodes 16a and 17, that is, the phase difference of charges propagating through the ground electrodes is eliminated by the radio frequency electrical signal on the RF electrode 15a. It is possible to manufacture a broadband Si optical modulator in which deterioration of transmission characteristics and reflection characteristics of the RF signal 21 input to the RF electrode 15a is suppressed.

In a semiconductor optical modulator such as InP or Si, a reverse bias voltage is applied to the pn junction portion or the pin junction portion at the center of the core together with a radio frequency (RF) modulation electrical signal. That is, a voltage with a positive potential on the high-concentration n-type semiconductor layer 214 side and a negative potential on the high-concentration p-type semiconductor layer 211 is applied from the right end to the left end of the optical waveguide 200 (in the x-axis direction). The reverse bias voltage and the modulation electrical signal change the carrier density inside the core of the thick Si layer 201. With changing the carrier density to cause a change in the refractive index of the core 201 of the optical waveguide due to the carrier plasma effect, the phase of light propagating through the core of the optical waveguide can be modulated.

FIG. 9 illustrates a drive circuit of a conventional single-electrode type Mach-Zehnder type optical modulator, and FIG. 10 illustrates a drive circuit of a conventional dual-electrode type Mach-Zehnder type optical modulator. A driver IC 300 with an open collector type output stage is connected to one end of the RF electrode of the optical modulator, and a terminating resistor R_{L} is connected to the other end. The open collector driver has no sending-end resistance and can be connected to an optical modulator with any impedance. Therefore, when the open collector driver is used, the power consumed by the sending-end resistance can be reduced, and an optical modulator with high power efficiency and low power consumption can be provided.

In addition, since it is not necessary to dispose a DC block capacitor on the RF wiring between the driver IC 300 and an optical modulator 100, the implementation form can be made compact. Further, power is supplied to the driver IC 300 via the RF electrodes 15a and 15b of the optical modulator, and a supply voltage (VCC) to the driver IC 300 can be set as a bias voltage of the optical modulator. Therefore, the power supply of the bias voltage and the power supply to the driver IC can be covered by a single power supply.

However, for the driving condition of the driver IC, the optimum driving condition of the driver IC is determined by the adjustment of the gain amount, the adjustment of the peaking amount of the frequency band, the power consumption, and the like, and therefore the value of the supply voltage (VCC) is also determined by the optimum condition of the driver IC. Therefore, when the supply voltage (VCC) of the driver IC and the optimum bias voltage of the Si optical modulator are not the same, each requires a voltage adjustment function. In a case where high performance is required for the optical modulator, such as a case where high speed and long distance transmission are required, it is necessary to adjust the bias voltage to the pn junction portion.

In addition, this problem can be solved in a single-electrode type optical modulator in which an RF electrode and a DC bias electrode are separately provided. On the other hand, in a dual-electrode type optical modulator in which a DC bias voltage is applied to an RF electrode in an overlapping manner, there is a problem that it is impossible to adjust to an optimum bias condition of the optical modulator.

### CITATION LIST

### Patent Literature

Patent Literature 1: JP 6499804 B2

### Non Patent Literature

Non Patent Literature 1: Goi Kazuhiro, Oda Kenji, Kusaka Hiroyuki, Ogawa Kensuke, Tsung-Yang Liow, Xiaoguang Tu, Guo-Qiang Lo, Dim-Lee Kwong, “20 Gbps binary phase shift keying using silicon Mach-Zehnder push-pull modulator”, The Institute of Electronics Information and Communication Engineers Electronics Society Convention 2012, C-3-50, 2012
Non Patent Literature 2: Po Dong, Long Chen, and Young-kai Chen, “High-speed low-voltage single-drive push-pull silicon Mach-Zehnder modulators” Opt. Express vol. 20, no. 6, pp. 6163-6169, 2012.

### SUMMARY OF INVENTION

An object of the present invention is to provide an optical modulator that can be adjusted to an optimum bias condition even in a dual-electrode type structure.

In order to achieve such an object, an embodiment of the present invention is an optical modulator including a semiconductor layer with a pn junction in an optical waveguide core, and an RF electrode and a ground electrode for applying a radio frequency (RF) signal to the semiconductor layer, the optical modulator modulating an optical signal by applying a bias voltage to the semiconductor layer together with the RF signal, the optical modulator including: a bias electrode disposed to face the ground electrode inside a substrate, in which the RF electrode and the bias electrode are connected to the semiconductor layer.

### BRIEF DESCRIPTION OF DRAWINGS

FIG. 1 is a diagram illustrating a cross-sectional structure of an optical waveguide as the basis of a Si optical modulator of a conventional technique.

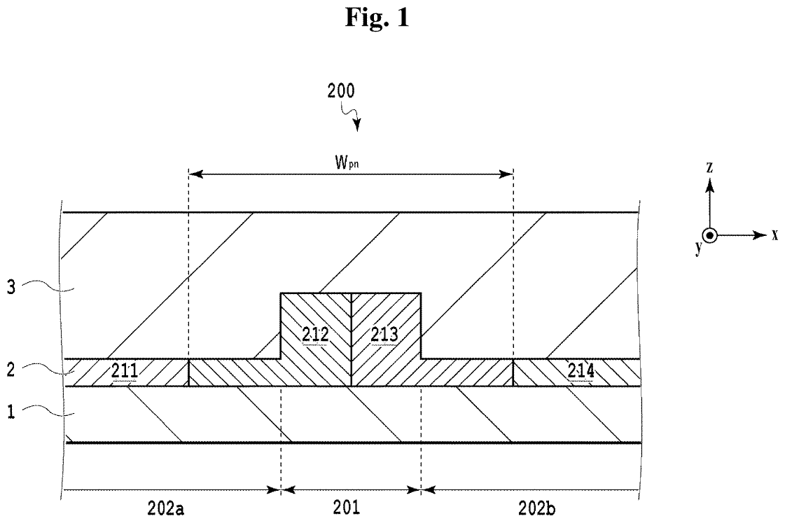

FIG. 2 is a plan diagram illustrating a Si optical modulator constituting a conventional single-electrode type Mach-Zehnder type optical modulator.

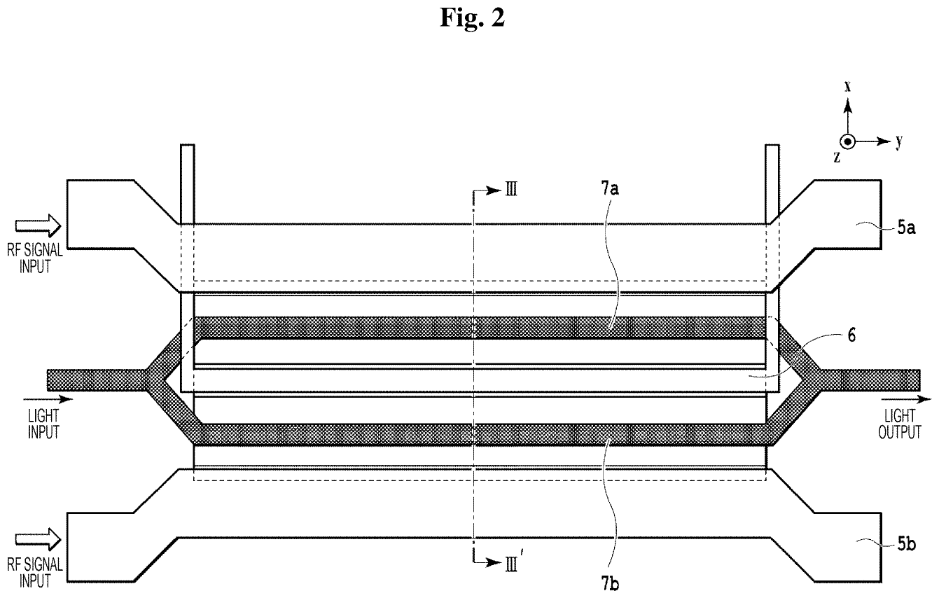

FIG. 3 is a cross-sectional diagram illustrating a Si optical modulator constituting a conventional single-electrode type Mach-Zehnder type optical modulator.

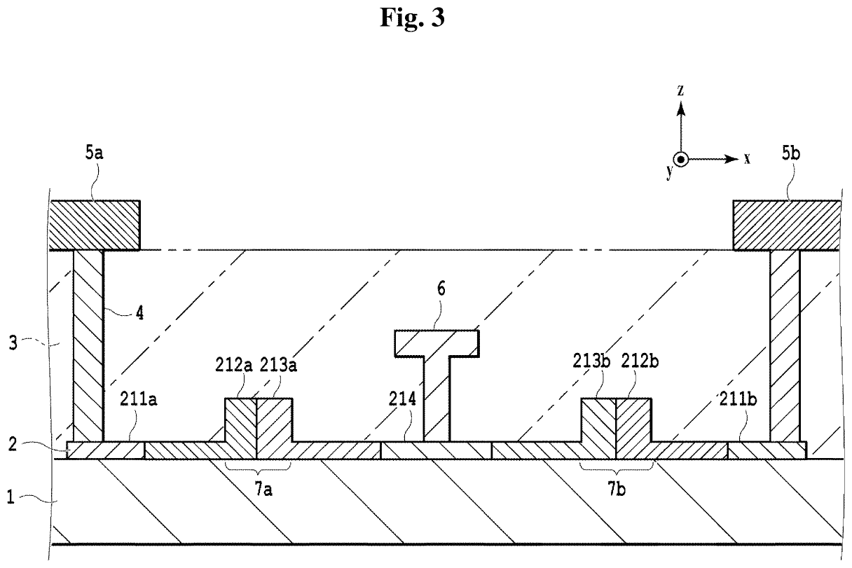

FIG. 4 is a plan diagram illustrating a Si optical modulator constituting a conventional dual-electrode type Mach-Zehnder type optical modulator.

FIG. 5 is a cross-sectional diagram illustrating a Si optical modulator constituting a conventional dual-electrode type Mach-Zehnder type optical modulator.

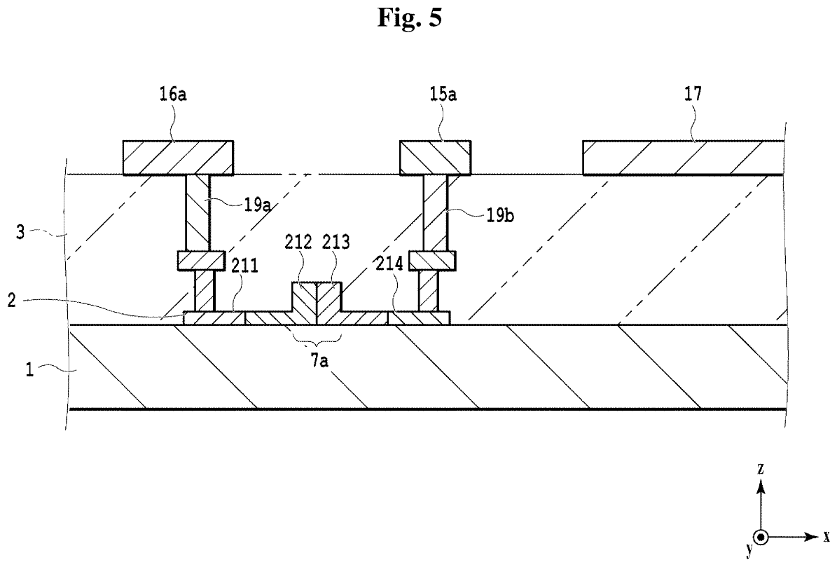

FIG. 6 is a diagram for describing a propagation state in a dual-electrode Si optical modulator with a CPW structure.

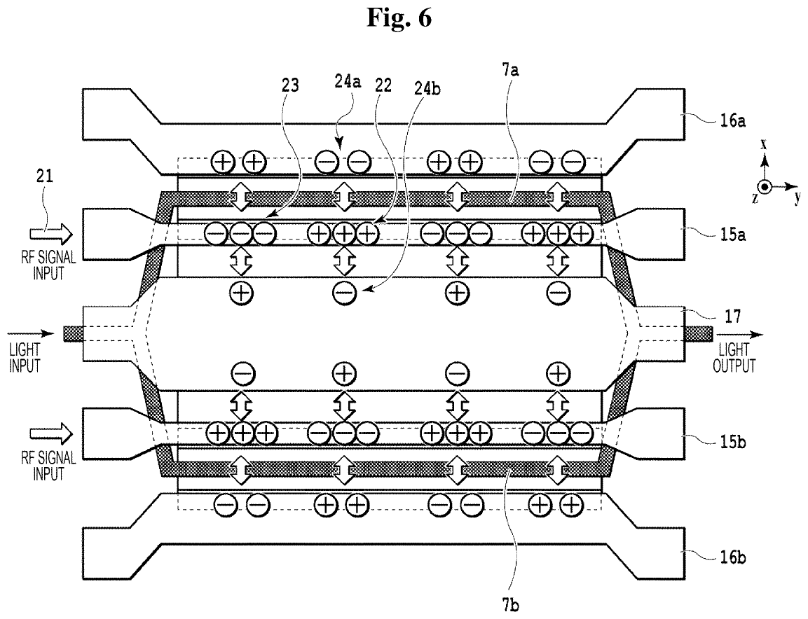

FIG. 7 is a plan diagram illustrating a dual-electrode Si optical modulator with a conventional CPW structure.

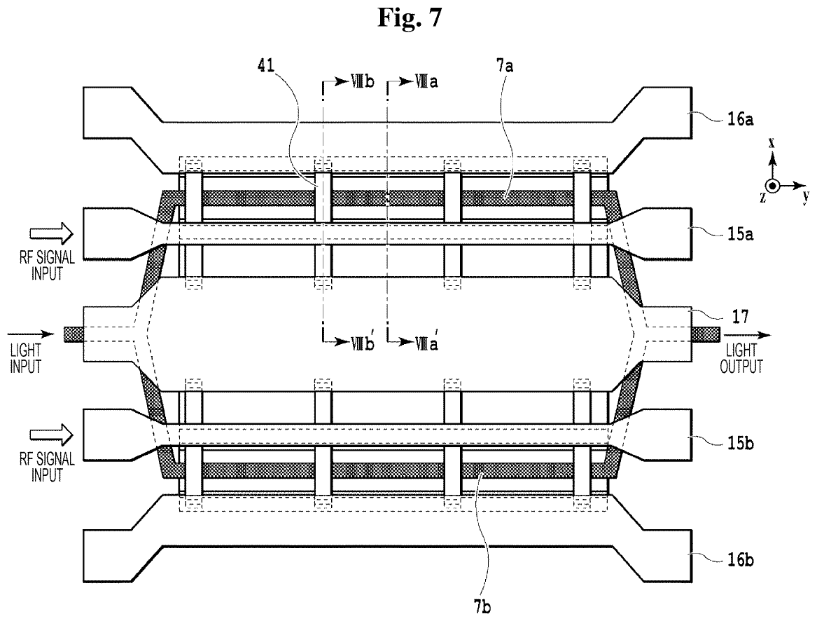

FIG. 8 is a cross-sectional diagram illustrating a dual-electrode Si optical modulator with a conventional CPW structure.

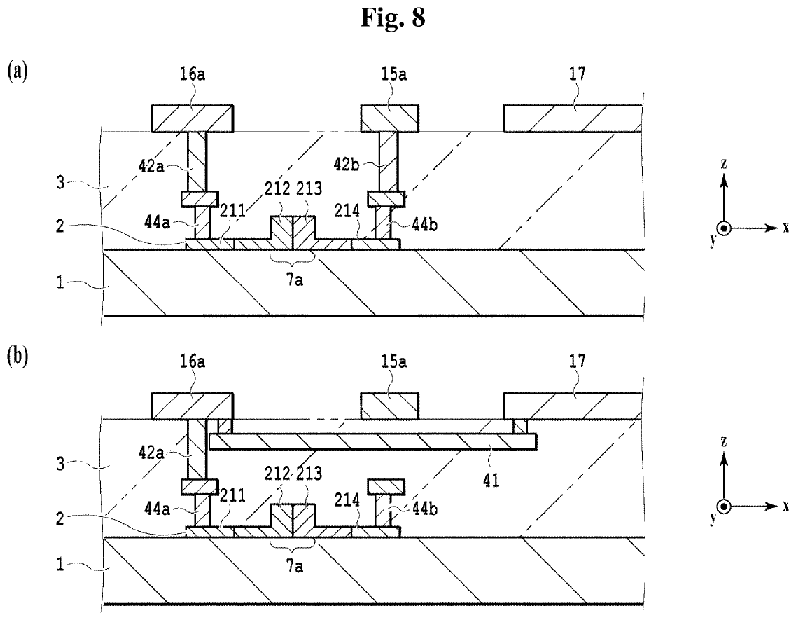

FIG. 9 is a diagram illustrating a drive circuit of a conventional single-electrode type Mach-Zehnder type optical modulator.

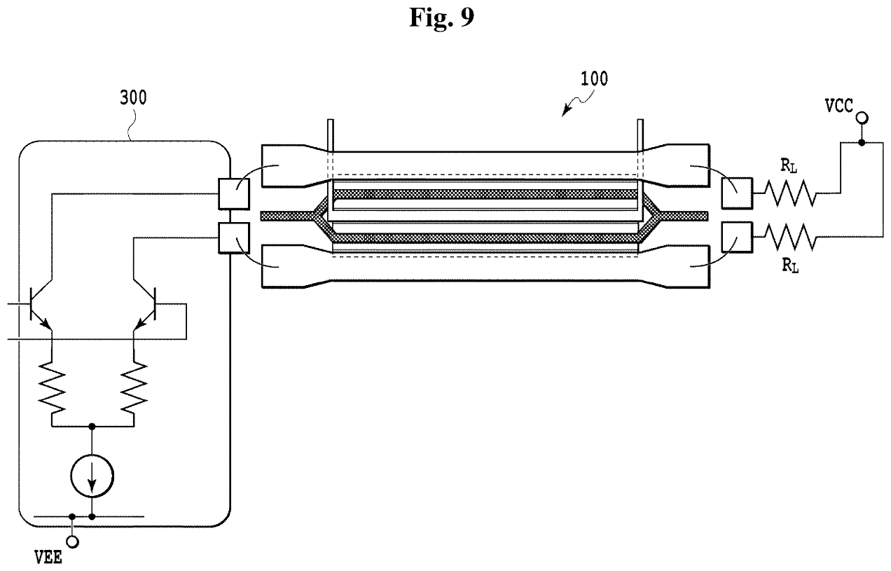

FIG. 10 is a diagram illustrating a drive circuit of a conventional dual-electrode type Mach-Zehnder type optical modulator.

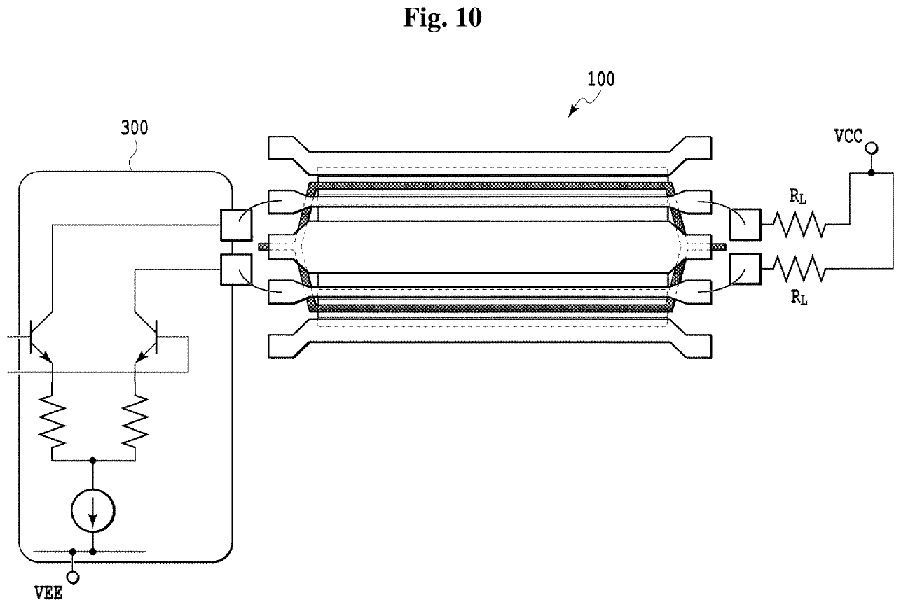

FIG. 11 is a plan diagram illustrating a dual-electrode Si optical modulator according to Example 1 of the present invention.

FIG. 12 is a cross-sectional diagram illustrating a dual-electrode Si optical modulator according to Example 1 of the present invention.

FIG. 13 is a diagram illustrating a distribution of charges when a modulation electrical signal is applied to the Si optical modulator of Example 1.

FIG. 14 is a cross-sectional diagram illustrating a dual-electrode Si optical modulator according to Example 1 of the present invention.

### DESCRIPTION OF EMBODIMENTS

An embodiment of the present invention will be described in detail below with reference to the drawings. The optical modulator of the present embodiment is a dual-electrode Si optical modulator with a CPW structure, and includes an electrode that applies a bias voltage separate from a bias voltage applied to the optical modulator together with an RF signal applied to an RF electrode. Also in the dual-electrode type structure, since it can be adjusted to the optimum bias condition, it is possible to provide a high-quality and high-performance optical modulator capable of operating at a higher speed and applicable to long-distance optical communication. In addition, the optical modulator of the present embodiment can be manufactured by a CMOS compatible process suitable for mass production, and a low-cost optical modulator can be provided.

### Example 1

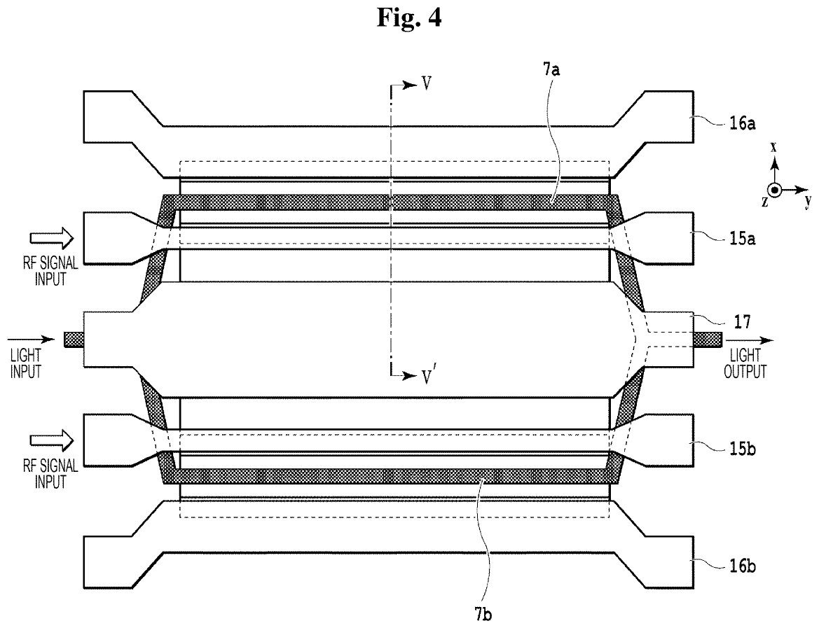

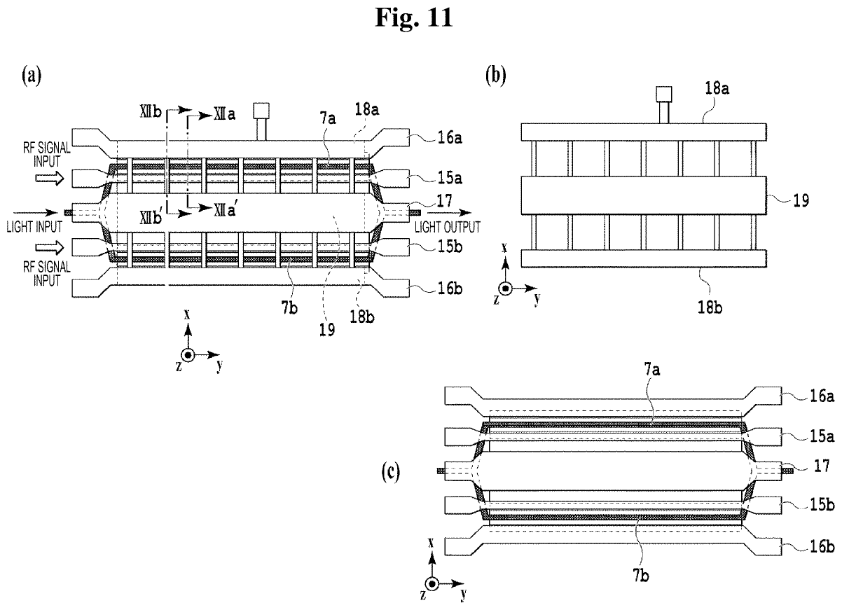

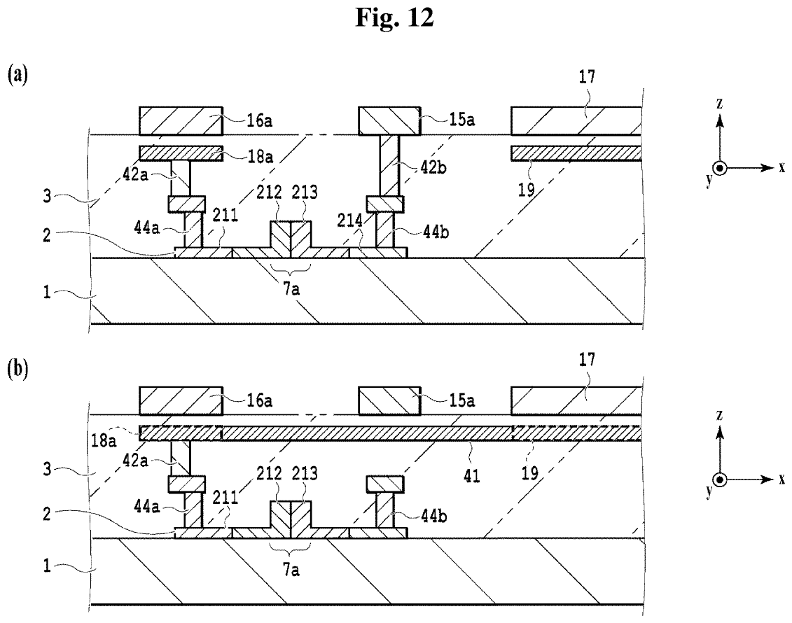

FIGS. 11 and 12 illustrate a dual-electrode Si optical modulator according to Example 1 of the present invention. FIG. 11(a) illustrates a planar structure of a Si (SOI) substrate surface (x-y plane) seen through from above, and FIG. 11(b) illustrates a planar structure in which only a bias electrode is extracted. FIG. 11(c) illustrates a planar structure excluding the bias electrode, which is the same as the structure of the conventional dual-electrode Si optical modulator illustrated in FIG. 4. The light input from the left optical modulator end is split into two optical waveguides 7a and 7b, modulated, and then coupled again, and to be optically output as modulated light from the right optical modulator end. The input light is phase-modulated by a radio frequency (RF) modulation electrical signal applied to each of RF electrodes 15a and 15b while propagating through the two split optical waveguides 7a and 7b in the y-axis direction. The optical modulator has a CPW including two ground electrodes 16a and 17 sandwiching the RF electrode 15a for the optical waveguide 7a. Similarly, it has a CPW including two ground electrodes 16b and 17 sandwiching the RF electrode 15b for the optical waveguide 7b. The optical modulator of Example 1 is different from the conventional optical modulator in the structure of the ground electrodes, and will be described in detail with reference to a cross-sectional diagram.

FIG. 12(a) illustrates a cross-sectional structure of XIIa-XIIa′ in FIG. 11(a), and FIG. 12(b) illustrates a cross-sectional structure of XIIb-XIIb′ in FIG. 11(a). One optical waveguide core 7a is provided between the RF electrode 15a and the ground electrode 16a, and a pn junction structure including the medium-concentration p-type semiconductor layer 212 and the medium-concentration n-type semiconductor layer 213 is formed in the optical waveguide core 7a. The RF electrode 15a is in contact with the high-concentration n-type semiconductor layer 214 through vias 42b and 44b.

Similarly to the ground electrode 17, the ground electrode 16a is not in contact with any semiconductor layer, and forms a CPW for the RF electrode 15a. Additionally, a bias electrode 18a disposed close to and to face the ground electrode 16a inside the substrate is in contact with the high-concentration p-type semiconductor layer 211 through the vias 42a and 44a. Further, a bias electrode 19 disposed close to and to face the ground electrode 17 inside the substrate is provided. As described above, it is different from the conventional optical modulator in that the ground electrodes sandwiching the RF electrode 15a have a structure divided into the ground electrode and the bias electrode.

In addition, in the optical modulator of Example 1, the wiring electrode 41 with a linear shape connects the two bias electrodes 18a and 19 without forming a via connected from the RF electrode 15a to the Si semiconductor layer 214. Accordingly, the wiring electrode 41 is not in contact with the RF electrode 15a and the via 42b. The two ground electrodes 16a and 17 are not connected by a wiring electrode, and this point is also different from the conventional optical modulator.

The ground electrodes 16a and 17 are connected to a ground pad, which is not illustrated, and are connected to a ground pad of the driver IC or a ground pad of a package that houses the optical modulator. The bias electrodes 18a and 19 are connected to a pad, which is not illustrated, for supplying a bias voltage, and a reverse bias voltage can be individually applied to the optical modulator.

The optical modulator of Example 1 is connected to a driver IC with an open collector type output stage. At this time, a reverse bias voltage (Vpn) applied to the pn junction portion of the optical modulator is a difference between the supply voltage (VCC) applied to the RF electrodes 15a and 15b and the voltage (Vbias) applied to the bias electrodes 18a and 18b.

$$Vpn = VCC - Vbias$$

First, the supply voltage (VCC) to the driver IC is determined such that the driving condition of the driver IC is optimized. Next, the reverse bias voltage (Vpn) is set by adjusting the voltage (Vbias) applied to the bias electrodes 18a and 18b so that an optimum bias voltage is applied to the pn junction portion of the Si optical modulator.

As a result, it is possible to set optimum driving conditions for both the driver IC and the optical modulator, and it is possible to provide a high-quality and high-performance optical modulator capable of operating at a higher speed and applicable to long-distance optical communication.

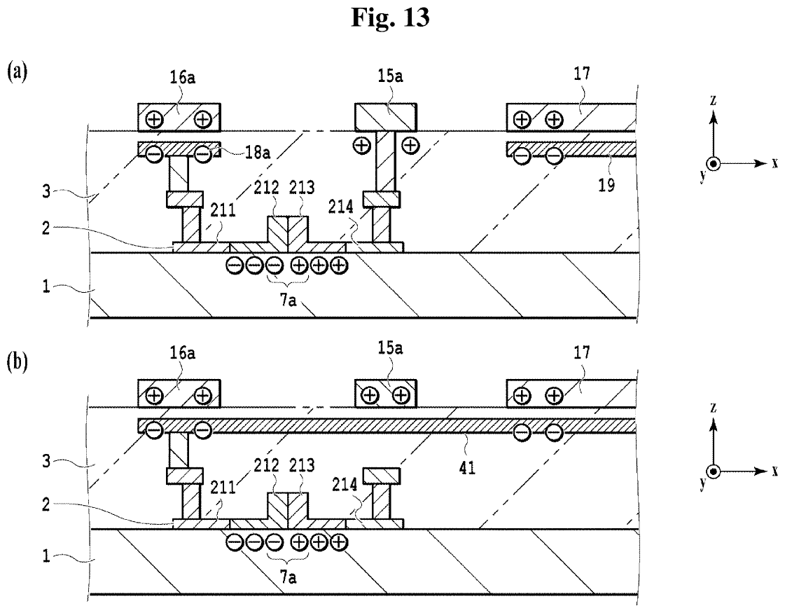

FIG. 13 illustrates a distribution of charges when a modulation electrical signal is applied to the Si optical modulator of Example 1. FIG. 13(a) illustrates a distribution of charges in a cross-section of XIIa-XIIa′ in FIG. 11(a), and FIG. 13(b) illustrates a distribution of charges in a cross-section of XIIb-XIIb′ in FIG. 11(a). The CPW is one of unbalanced lines in which the charges of the RF line are balanced with the charges with opposite polarities induced in each of the two ground electrodes. The charges are concentrated in the vicinity of the pn junction portion in the Si optical waveguide where the distance between the electrodes is the narrowest, but are also distributed over the electrodes themselves. FIG. 13 illustrates a state in which positive charges are present on the RF electrode 15a at a certain time point when the RF signal is input.

At this time, charges induced to the bias electrode 18a through the pn junction portion are negative charges. Since the bias electrode 18a and the ground electrode 16a face each other and close to each other across the thin SiO₂ cladding layer 3, they operate as a capacitor and induce positive charges in the ground electrode 16a. When the RF signal propagates through the electrode 15a, the induced charges also propagate through the bias electrode 18a and the ground electrode 16a closed thereto. Therefore, the bias electrode 18a and the ground electrode 16a are separated in terms of direct current (DC), and can be considered as an integrated electrode in terms of alternating current (AC). In other words, the core of the optical modulator of Example 1 is connected to the ground electrode in terms of alternating current for the radio frequency (RF) modulation electrical signal and is connected to the bias electrode in terms of direct current for the bias voltage. Accordingly, it is possible to perform a modulation operation by the RF signal, and it is possible to apply voltages based on different potentials: a bias potential and a ground potential.

In a case where the bias electrode 18a and the ground electrode 16a are not sufficiently close to each other but are separated from each other, or the facing overlapping area is relatively small, they do not sufficiently function as a capacitor, and charges are not induced. At this time, the bias electrode 18a and the ground electrode 16a cannot be considered as an integrated electrode in terms of RF voltage. The bias electrode 18a resonates with the radio frequency signal induced by the RF electrode 15a, and a phenomenon occurs in which propagation of the RF signal is not successful at a specific frequency. This is a factor causing characteristic deterioration of the optical modulator required to modulate light in a wide frequency band. Therefore, in the Si (SOI) substrate, not only when the bias electrode 18a and the ground electrode 16a are close to each other in the Z-axis direction, but also as the wider the area in which the bias electrode 18a and the ground electrode 16a overlap each other in the x-y plane, the more effective the structure. Note that resonance caused by the RF signal is likely to occur when the length between the ground electrodes 16a and 17 and the ground pad and the length between the bias electrodes 18a and 19 and the pad for supplying the bias voltage are ½ or ¼ of the wavelength of the propagating RF signal.

### Example 2

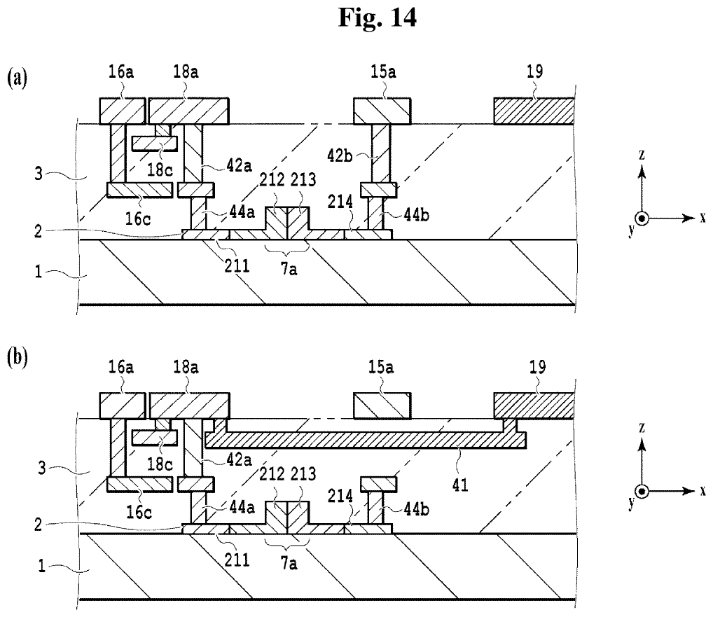

FIG. 14 illustrates a dual-electrode Si optical modulator according to Example 2 of the present invention. The optical modulator of Example 2 is different from the conventional optical modulator and the optical modulator of Example 1 in the structure of the ground electrodes. FIG. 14(a) illustrates a cross-sectional structure without the wiring electrode 41 connecting between the two bias electrodes 18a and 19, similarly to FIG. 13(a), and FIG. 14(b) illustrates a cross-sectional structure with the wiring electrode 41, similarly to FIG. 13(b). The bias electrode 18a and the ground electrode 16a are provided on an upper surface of the Si (SOI) substrate, and are connected to a bias electrode 18c and a ground electrode 16c formed inside the SiO₂ cladding layer 3, respectively, by vias. Although a pair of electrodes is formed in the z-axis direction in FIG. 14, a plurality of pairs of electrodes may be formed. In this manner, the area of the capacitor formed by the bias electrode 18c and the ground electrode 16c can be increased.

Therefore, the range of frequencies in which the bias electrode 18a and the ground electrode 16a can be considered as an integrated electrode in terms of RF voltage is widened. That is, as the area of the capacitor increases and the capacitance increases, it is possible to follow the movement of charges to a lower frequency. In addition, since the larger the capacitance of the capacitor, the larger the amount of charges accumulated between the electrodes, the Coulomb force due to positive and negative charges works strongly, and the bias electrode 18a and the ground electrode 16a can be considered as being integrated more in terms of RF voltage.

In addition, in the optical modulator of Example 2, the ground electrode 17 is omitted, and only the bias electrode 19 adjacent to the ground electrode 17 is provided. As described above, since the bias electrode 19 and the ground electrode 17 can be considered as being integrated in terms of RF voltage, either one may be provided, and the other one may be omitted.

### INDUSTRIAL APPLICABILITY

In general, the present invention can be applied to an optical communication system. In particular, it can be applied to an optical modulator in an optical transmitter of an optical communication system.

1. An optical modulator comprising:
a semiconductor layer with a pn junction in an optical waveguide core;
an RF electrode and a ground electrode configured to apply a radio frequency (RF) signal to the semiconductor layer, an optical signal being modulated by applying a bias voltage to the semiconductor layer together with the RF signal; and
a bias electrode disposed to face the ground electrode inside a substrate, wherein
the RF electrode and the bias electrode are connected to the semiconductor layer.

2. The optical modulator according to claim 1, wherein
a capacitor is formed by the ground electrode and the bias electrode, and
the semiconductor layer is connected to the ground electrode in terms of alternating current for the RF signal, and is connected to the bias electrode in terms of direct current for the bias voltage.

3. The optical modulator according to claim 1, wherein the ground electrode includes a first ground electrode and a second ground electrode sandwiching the RF electrode, and constitutes a coplanar waveguide (CPW) together with the RF electrode, the bias electrode includes a first bias electrode facing the first ground electrode and a second bias electrode facing the second ground electrode, and the first bias electrode is connected to the semiconductor layer.

4. The optical modulator according to claim 1, wherein the ground electrode and the bias electrode overlap and face each other over a plurality of layers in a direction perpendicular to a surface of the substrate.
